(19) United States
(12) Patent Application Publication
(10) Pub. No.: US 2024/0292368 A1
(43) Pub. Date: Aug. 29, 2024

(54) METHOD, USER EQUIPMENT, AND NETWORK NODE

(71) Applicant: NEC Corporation, Minato-ku, Tokyo (JP)

(72) Inventors: Yuhua Chen, London (GB); Neeraj Gupta, London (GB)

(73) Assignee: NEC Corporation, Minato-ku, Tokyo (JP)

(21) Appl. No.: 18/693,216

(22) PCT Filed: Oct. 5, 2022
(86) PCT No.: PCT/JP2022/037225

§ 371 Date: Mar. 19, 2024

(30) Foreign Application Priority Data
Oct. 21, 2021 (GB) 2115145.1

(51) Int. Cl. H04W 64/00; H04W 24/10; H04W 48/20; H04W 84/06

(52) U.S. Cl. CPC H04W 64/00; H04W 24/10; H04W 48/20; H04W 84/06

(57) ABSTRACT

A method performed by a user equipment (UE) configured to communicate via a network including a non-terrestrial network portion is disclosed. The method comprises performing a procedure. The procedure includes performing measurements with respect to at least one cell in a set of candidate cells; and performing a cell selection based on a result of the measurements. The procedure is performed based on at least one parameter for the at least one cell including at least one of remaining serving time of each of the at least one cell, distance between a current location of the UE and each of the at least one cell, distance between the current location of the UE and a serving cell, and mobility of the UE.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements relating to mobility in the so-called ‘5G’ (or ‘Next Generation’) systems employing a non-terrestrial portion comprising airborne or spaceborne network nodes.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. End-user communication devices are commonly referred to as User Equipment (UE) which may be operated by a human or comprise automated devices. Such communication devices might be, for example, mobile communication devices such as mobile telephones, smartphones, smart watches, personal digital assistants, laptop/tablet computers, web browsers, e-book readers, connected vehicles, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC, IoT/Industrial IoT (IIoT) communications, vehicular communications and autonomous cars, high resolution video streaming, smart city services, and/or the like. 3GPP intends to support 5G by way of the so-called 3GPP Next Generation (NextGen) radio access network (RAN)/radio access technology (RAT) and the 3GPP NextGen core (NGC) network. Various details of 5G networks are described in, for example, NPL 1.

3GPP is also working on specifying an integrated satellite and terrestrial network infrastructure in the context of 4G and 5G. The term Non-Terrestrial Networks (NTN) refers to networks, or segments of networks, that are using an airborne or spaceborne vehicle for transmission. Satellites refer to spaceborne vehicles in Geostationary Earth Orbit (GEO) or in Non-Geostationary Earth Orbit (NGEO) such as Low Earth Orbits (LEO), Medium Earth Orbits (MEO), and Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS—all operating quasi-stationary at an altitude typically between 8 and 50 km.

NPL 2 is a study on New Radio to support such Non-Terrestrial Networks. The study includes, amongst others, NTN deployment scenarios and related system parameters (such as architecture, altitude, orbit etc.) and a description of adaptation of 3GPP channel models for Non-Terrestrial Networks (propagation conditions, mobility, etc.). NPL 3 provides further details about NTN.

Non-Terrestrial Networks are expected to:
help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere: especially for critical communications, future railway/maritime/aeronautical communications; and
enable 5G network scalability through the provision of efficient multicast/broadcast resources for data delivery towards the network edges or even directly to the user equipment.

NTN access typically features the following elements (amongst others):
NTN Terminal: It may refer to a 3GPP UE or a terminal specific to the satellite system in case the satellite doesn't serve directly 3GPP UEs.
A service link which refer to the radio link between the user equipment and the space/airborne platform (which may be in addition to a radio link with a terrestrial based RAN).
A space or an airborne platform.
Gateways (‘NTN Gateways’) that connect the satellite or aerial access network to the core network. It will be appreciated that gateways will mostly likely be co-located with a base station.
Feeder links which refer to the radio links between the gateways and the space/airborne platform.

Satellite or aerial vehicles may generate several beams over a given area to provide respective NTN cells. The beams have a typically elliptic footprint on the surface of the Earth.

3GPP intends to support three types of NTN beams or cells:
Earth-fixed cells characterized by beam(s) covering the same geographical areas all the time (e.g. GEO satellites and HAPS);
quasi-Earth-fixed cells characterized by beam(s) covering one geographic area for a finite period and a different geographic area during another period (e.g. NGEO satellites generating steerable beams); and
Earth-moving cells characterized by beam(s) covering one geographic area at one instant and a different geographic area at another instant (e.g. NGEO satellites generating fixed or non-steerable beams).

With satellite or aerial vehicle keeping position fixed in terms of elevation/azimuth with respect to a given earth point e.g. GEO and UAS, the beam footprint is earth fixed.

With satellite circulating around the earth (e.g. LEO) or on an elliptical orbit around the earth (e.g. HEO) the beam footprint may be moving over the Earth with the satellite or aerial vehicle motion on its orbit. Alternatively, the beam footprint may be Earth-fixed (or quasi-Earth-fixed) temporarily, in which case an appropriate beam pointing mechanism (mechanical or electronic steering) may be used to compensate for the satellite or aerial vehicle motion.

LEO satellites may have steerable beams in which case the beams are temporarily directed to substantially fixed footprints on the Earth. In other words, the beam footprints (which represent NTN cell) are stationary on the ground for a certain amount of time before they change their focus area over to another NTN cell (due to the satellite's movement on its orbit). From cell coverage/UE point of view, this results in cell changes happening regularly at discrete intervals because different Physical Cell Identities (PCIs) and/or Synchronization Signal/Physical Broadcast Channel (PBCH) blocks (SSBs) have to be assigned after each service link change, even when these beams serve the same land area (have the same footprint). LEO satellites without steerable beams cause the beams (cells) moving on the ground constantly in a sweeping motion as the satellite moves along its orbit and as in the case of steerable beams, service link change and consequently cell changes happen regularly at discrete intervals. Similarly to service link changes, feeder link changes also happen at regular intervals due to the satellite's movement on its orbit. Both service and feeder link changes may be performed between different base stations/gateways (which may be referred to as an ‘inter-gNB radio link switch’) or within the same base station/gateway (‘intra-gNB radio link switch’).

In 3GPP systems, cell selection and reselection are facilitated by the base stations broadcasting appropriate information (e.g. parameters/thresholds to be used and/or UE measurements to be performed) for calculating their associated cell (re)selection criterion ‘S’ based on which UEs can evaluate whether or not to select a particular cell to camp on (e.g. when the UE is operating in RRC idle or inactive state). Similarly, such a cell selection criterion S may be used when selecting a suitable handover cell (e.g. a neighbour cell). The cell selection criterion S includes a set of sub-criteria comprising for example the ‘Srxlev’ sub-criteria that specifies a cell selection receiver (RX) level value (dB) and the ‘Squal’ sub-criteria that specifies a cell selection quality value (dB). For a given cell, the cell selection criterion S is fulfilled when Srxlev>0, and Squal>0 (for that cell).

According to NPL 4, a UE may not need to measure intra-frequency cells and/or inter-frequency cells of equal or lower priority if the serving cell's Srxlev/Squal is higher than their configured thresholds. However, the UE is always expected to measure inter-frequency cell cells of higher priority.

NPL 4 also specifies the rules for relaxed measurements, such as relaxed measurement criterion for certain UEs. In summary, relaxed measurements (e.g. less frequent measurements) may be applied for UEs with low mobility (criterion: serving cell's signal strength change in a time duration is less than an associated threshold) and/or UEs that are not at the cell edge (criterion: serving cell signal strength is better than an associated threshold).

In case of NR inter-frequency and inter-RAT cell reselection and in case of intra-frequency and equal priority inter-frequency cell reselection some special criteria may be applied. In such cases, cell reselection to a higher priority RAT/frequency cell shall take precedence over a lower priority RAT/frequency cell, as follows:
for inter-frequency with higher priority: always select to the frequency if a cell on that frequency fulfils the associated signal strength or quality threshold;
for intra-frequency and inter-frequency with equal priority: perform cell reselection based on ranking (i.e. reselect to the best available cell having the same priority); and
for inter-frequency with lower priority: select to the frequency only if the serving cell signal is worse than an associated threshold and the cell on the frequency is better than an associated threshold.

### CITATION LIST

### Non Patent Literature

NPL 1: the ‘NGMN 5G White Paper’ V1.0, Next Generation Mobile Networks (NGMN) Alliance, <https://www.ngmn.org/5g-white-paper.html>
NPL 2: 3GPP TR 38.811 V15.4.0
NPL 3: 3GPP TR 38.821 V16.1.0
NPL 4: 3GPP TS 38.304 v16.6.0
NPL 5: 3GPP TS 38.133 v16.9.0
NPL 6: 3GPP TS 38.300 V16.7.0
NPL 7: 3GPP TS 37.340 V16.7.0

### SUMMARY OF INVENTION

### Technical Problem

The inventors have identified at least the following issues with the current approach when applied to cells of NTN networks:
NTN cells are characterised by a relatively small signal strength variation from cell centre to cell edge, compared to the signal strength variation in conventional, non-NTN cells (see FIGS. 5A and 5B). Thus, signal strength-based cell reselection may not work well for NTN cells, since it may be difficult for a UE to distinguish between the cell centre and cell edge based on signal strength and/or it may be difficult to detect a suitable neighbouring cell (for cell reselection purpose) with obviously better signal strength than the current cell as the difference between two cells will remain relatively small as the UE approaches the edge of a candidate cell.
In NTN systems, a given cell (e.g. Cell A) may be switched off and another cell (e.g. Cell B) may be switched on to replace that cell. The new cell (Cell B) may not necessarily cover the same area as the cell being switched off (Cell A). In this case, all UEs camping on the affected cell need to reselect to another cell. Ideally, these UEs need to avoid reselecting to the same cell (Cell A) if that cell is going to disappear soon. Such cell switch off may happen due to the satellite moving and/or any other reason, for example, due to service link and feeder link switching as shown in FIGS. 6A and 6B. A cell (e.g. an NTN cell) may also be switched on/off for optimising cell capacity (in the terrestrial network). For example, a cell may be switched off due to relatively low traffic/low number of RRC connections in that cell (and switched on due to high traffic/load in the terrestrial network).

The present disclosure seeks to provide methods and associated apparatus that address or at least alleviate (at least some of) the above-described issues.

### Solution to Problem

In one aspect, the disclosure provides a method performed by a user equipment (UE) configured to communicate via a network comprising a non-terrestrial network portion, the method comprising: performing measurements with respect to at least one cell in a set of candidate cells; and performing a cell selection based on a result of said measurements and at least one of respective timing information and location information for said set of candidate cells: wherein the method comprises at least one of: excluding from said measurement or from said cell selection at least one candidate cell having an associated remaining serving time less than a first threshold: excluding from said measurement or from said cell selection at least one candidate cell in a case that a distance from the current location of the UE to its serving cell is smaller than a second threshold: applying relaxed measurements to at least one candidate cell in a case that a distance from the current location of the UE to the serving cell is smaller than a third threshold: applying relaxed measurements to at least one candidate cell in a case that a mobility of the UE is lower than a fourth threshold; and excluding at least one candidate cell from said measurement or from said cell selection in a case that a distance from the current location of the UE to that candidate cell is larger than a fifth threshold.

In one aspect, the disclosure provides a method performed by a network node configured to communicate with a user equipment (UE) via a network comprising a non-terrestrial network portion, the method comprising: providing, to the UE, configuration information wherein the configuration information is adapted to assist the UE in performing measurements with respect to at least one cell in a set of candidate cells and performing a cell selection based on a result of said measurements and at least one of respective timing information and location information for said set of candidate cells: wherein the configuration information includes at least one threshold for the UE to use in at least one of: excluding from said measurement or from said cell selection at least one candidate cell having an associated remaining serving time less than a first threshold: excluding from said measurement or from said cell selection at least one candidate cell in a case that a distance from the current location of the UE to its serving cell is smaller than a second threshold: applying relaxed measurements to at least one candidate cell in a case that a distance from the current location of the UE to the serving cell is smaller than a third threshold: applying relaxed measurements to at least one candidate cell in a case that a mobility of the UE is lower than a fourth threshold; and excluding at least one candidate cell from said measurement or from said cell selection in a case that a distance from the current location of the UE to that candidate cell is larger than a fifth threshold.

In one aspect, the disclosure provides a user equipment (UE) configured to communicate via a network comprising a non-terrestrial network portion, the UE comprising: means (for example a memory, a transceiver, and a processor) for performing measurements with respect to at least one cell in a set of candidate cells; and means for performing a cell selection based on a result of said measurements and at least one of respective timing information and location information for said set of candidate cells: wherein the UE is configured to perform at least one of: exclude from said measurement or from said cell selection at least one candidate cell having an associated remaining serving time less than a first threshold: exclude from said measurement or from said cell selection at least one candidate cell in a case that a distance from the current location of the UE to its serving cell is smaller than a second threshold: apply relaxed measurements to at least one candidate cell in a case that a distance from the current location of the UE to the serving cell is smaller than a third threshold: apply relaxed measurements to at least one candidate cell in a case that a mobility of the UE is lower than a fourth threshold; and exclude at least one candidate cell from said measurement or from said cell selection in a case that a distance from the current location of the UE to that candidate cell is larger than a fifth threshold.

In one aspect, the disclosure provides a network node configured to communicate with a user equipment (UE) via a network comprising a non-terrestrial network portion, the network node comprising: means (for example a memory, a transceiver, and a processor) for providing, to the UE, configuration information wherein the configuration information is adapted to assist the UE in performing measurements with respect to at least one cell in a set of candidate cells and performing a cell selection based on a result of said measurements and at least one of respective timing information and location information for said set of candidate cells: wherein the configuration information includes at least one threshold for the UE to use in at least one of: excluding from said measurement or from said cell selection at least one candidate cell having an associated remaining serving time less than a first threshold: excluding from said measurement or from said cell selection at least one candidate cell in a case that a distance from the current location of the UE to its serving cell is smaller than a second threshold: applying relaxed measurements to at least one candidate cell in a case that a distance from the current location of the UE to the serving cell is smaller than a third threshold: applying relaxed measurements to at least one candidate cell in a case that a mobility of the UE is lower than a fourth threshold; and excluding at least one candidate cell from said measurement or from said cell selection in a case that a distance from the current location of the UE to that candidate cell is larger than a fifth threshold.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the disclosure will now be described, by way of example, with reference to the accompanying drawings in which:

FIG. 1 illustrates schematically a mobile (cellular or wireless) telecommunication system to which embodiments of the disclosure may be applied;

FIG. 2 is a schematic block diagram of a mobile device forming part of the system shown in FIG. 1;

FIG. 3 is a schematic block diagram of an NTN node (e.g. satellite/UAS platform) forming part of the system shown in FIG. 1;

FIG. 4 is a schematic block diagram of an access network node (e.g. base station) forming part of the system shown in FIG. 1;

FIG. 5A illustrates schematically some exemplary scenarios in which the present disclosure may be applied;

FIG. 5B illustrates schematically some exemplary scenarios in which the present disclosure may be applied;

FIG. 6A illustrates schematically some exemplary scenarios in which the present disclosure may be applied;

FIG. 6B illustrates schematically some exemplary scenarios in which the present disclosure may be applied; and

FIG. 7 illustrates schematically some exemplary architecture options for the provision of NTN features in the system shown in FIG. 1.

### DESCRIPTION OF EMBODIMENTS

### Overview

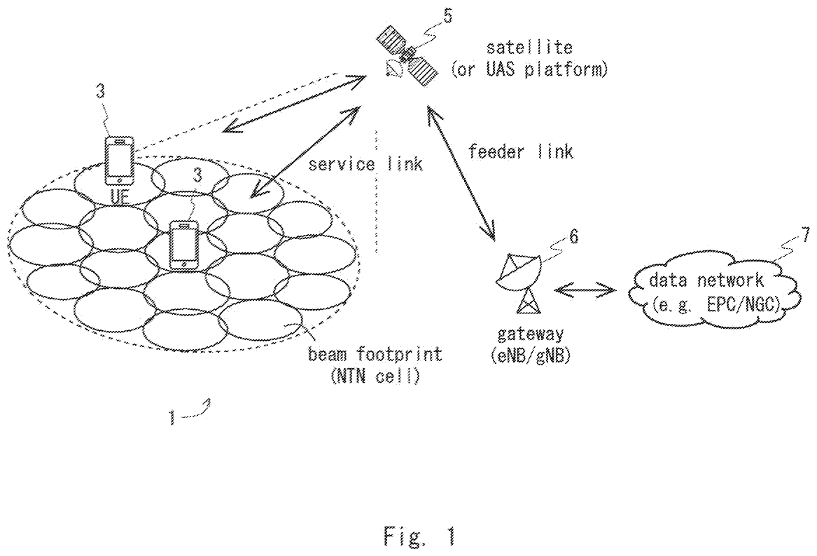

FIG. 1 illustrates schematically a mobile (cellular or wireless) telecommunication system 1 to which embodiments of the disclosure may be applied.

In this system 1, users of mobile devices 3 (UEs) can communicate with each other and other users via access network nodes respective satellites 5 and/or base stations 6 and a data network 7 using an appropriate 3GPP radio access technology (RAT), for example, an Evolved Universal Terrestrial Radio Access (E-UTRA) and/or 5G RAT. As those skilled in the art will appreciate, whilst two mobile devices 3, one satellite 5, and one base station 6 are shown in FIG. 1 for illustration purposes, the system, when implemented, will typically include other satellites/UAS platforms, base stations/RAN nodes, and mobile devices (UEs).

It will be appreciated that a number of base stations 6 form a (radio) access network or (R)AN, and a number of NTN nodes 5 (satellites and/or UAS platforms) form a Non-Terrestrial Network (NTN). Each NTN node 5 is connected to an appropriate gateway (in this case co-located with a base station 6) using a so-called feeder link and connected to respective UEs 3 via corresponding service links. Thus, when served by an NTN node 5, a mobile device 3 communicates data to and from a base station 6 via the NTN node 5, using an appropriate service link (between the mobile device 3 and the NTN node 5) and a feeder link (between the NTN node 5 and the gateway/base station 6). In other words, the NTN forms part of the (R)AN, although it may also provide satellite communication services independently of E-UTRA (or ‘4G’) and/or New Radio (or ‘5G’) communication services.

Although not shown in FIG. 1, neighbouring base stations 6 are connected to each other via an appropriate base station to base station interface (such as the so-called ‘X2’ interface, ‘Xn’ interface and/or the like). The base station 6 is also connected to the data network nodes via an appropriate interface (such as the so-called ‘S1’, ‘NG-C’, ‘NG-U’ interface, and/or the like).

The data (or core) network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the data network 7 of a ‘Next Generation’/5G system will include user plane entities and control plane entities, such as one or more control plane functions (CPFs) and one or more user plane functions (UPFs). The so-called Access and Mobility Management Function (AMF) in 5G, or the Mobility Management Entity (MME) in 4G, is responsible for handling connection and mobility management tasks for the mobile devices 3. The data network 7 is also coupled to other data networks such as the Internet or similar Internet Protocol (IP) based networks (not shown in FIG. 1).

Each NTN node 5 controls a number of directional beams via which associated NTN cells may be provided. Specifically, each beam has an associated footprint on the surface of the Earth which corresponds to an NTN cell. Each NTN cell (beam) has an associated Physical Cell Identity (PCI) and/or beam identity. The beam footprints may be moving as the NTN node 5 is travelling along its orbit. Alternatively, the beam footprint may be earth fixed, in which case an appropriate beam pointing mechanism (mechanical or electronic steering) may be used to compensate for the movement of the NTN node 5.

When the UE 3 initially establishes an RRC connection with a base station 6 via a cell it registers with an appropriate AMF 9 (or MME). The UE 3 is in the so-called RRC connected state and an associated UE context is maintained by the network. When the UE 3 is served via the NTN node 5, it receives and transmits data via one of the beams (NTN cells) of the NTN node 5. When the UE 3 is in the so-called RRC idle or in the RRC inactive state, it still needs to select an appropriate cell for camping so that the network is aware of the approximate location of the UE 3 (although not necessarily on a cell level).

Over time, due to movement of the UE 3 and/or movement of the serving NTN node 5, the UE 3 switches from cell to cell (beam to beam) using appropriate mobility procedures. In order to do so, the base station 6 provides the UE 3 appropriate configuration data and/or assistance information based on which the UE 3 can determine which cell to use, which cell(s) to measure, and when to switch from one cell to another.

When the UE 3 performs cell reselection among NTN cells, its operation may be different to its cell reselection operation for non-NTN (terrestrial) cells.

Specifically, in order to address the relatively low signal strength variation from cell centre to cell edge of NTN cells, the UEs 3 are configured to use a location-assisted cell reselection technique. This will beneficially allow the UEs 3 to distinguish between cell centre and cell edge and/or determine when they approach a suitable neighbouring cell for cell reselection (even if the signal strength for the neighbour cell is not better than the signal strength of the current cell).

In order to address the issue of switching off NTN cells (e.g. depending on system load), the UEs 3 are configured to use a time-assisted cell reselection technique. This will allow the UEs 3 to avoid reselecting to a cell which is about to be switched off or replaced by another cell. It will be appreciated that the location-assisted cell reselection technique and the time-assisted cell reselection technique may be used together, if appropriate. Some UEs 3 (or types of UEs) may be configured to use the location-assisted cell reselection technique, some UEs may be configured to use the time-assisted cell reselection technique, and some UEs may be configured to use both techniques.

In more detail, the following four options may be configured for a particular UE 3 (or group of UEs) for assisting its cell reselection operation:
Option 1: a UE 3 may be configured to exclude those neighbouring cells from cell reselection which have a remaining serving time less than an associated threshold;
Option 2: a UE 3 may be configured to not perform measurement on intra and inter frequency cells (at least cells with lower or equal priority to that of the current cell) if the UE's distance to the serving cell is smaller than an associated threshold (i.e. when the UE is relatively close to the cell centre or reference point of its current serving cell);
Option 3: a UE 3 may be configured to apply relaxed measurements if the UE's distance to the serving cell is smaller than an associated threshold (which may be the same threshold as in Option 2, or a different threshold) and/or if the UE is determined to be a low mobility UE based on an associated threshold; and
Option 4: a UE 3 may be configured to exclude those neighbouring cells from cell reselection to which the distance from the UE's current location is larger than an associated threshold (i.e. when the UE is relatively far from the edge, centre, or a suitable reference point of that neighbour cell).

Normally, these thresholds are configured via broadcast system information and applied to all UEs 3 camping on the corresponding cell (unless the thresholds are associated with a certain class/type of UE in which case they apply to those UEs only). It will be appreciated that these thresholds (at least one threshold) may be applied to a certain class/type of UEs (for example IoT UEs or power saving UEs rather than all UEs), and different thresholds (if any) may be defined for different classes/types of UEs. The thresholds may be factory configured for each UE (e.g. depending on its class/type, and/or network operator). If appropriate, the thresholds may also be (re)configured via dedicated signalling (e.g. RRC signalling using one or more appropriate information elements).

### User Equipment (UE)

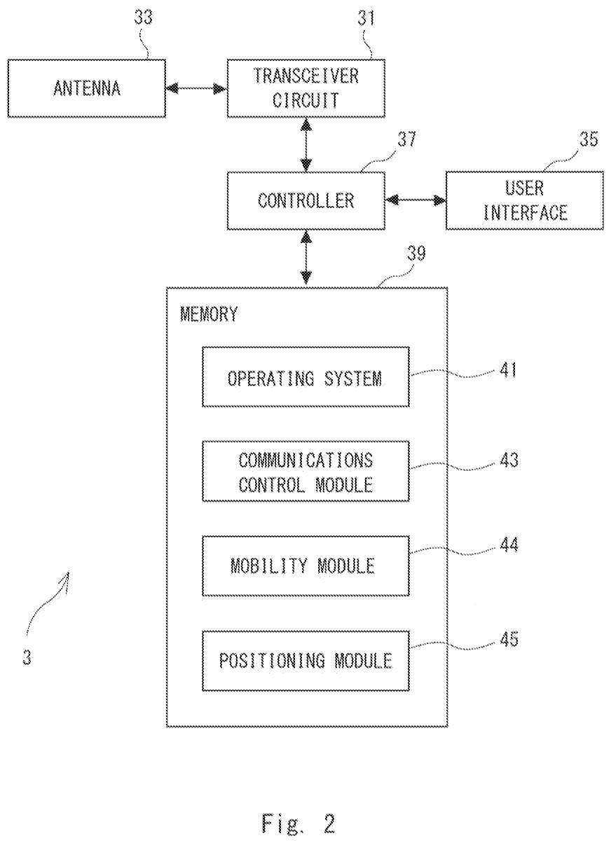

FIG. 2 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, a mobility module 44, and a positioning module 45 (which is optional in some UEs).

The communications control module 43 is responsible for handling (generating/sending/receiving) signalling messages and uplink/downlink data packets between the UE 3 and other nodes, including NTN nodes 5, (R)AN nodes 6, and core network nodes. The signalling may comprise control signalling (such as RRC signalling) related to configuring and assisting cell reselection by the UE 3.

The mobility module 44 is responsible for controlling mobility procedures for the UE 3 (in RRC connected, RRC idle, and RRC inactive state), based on appropriate assistance information (e.g. configuration/parameters) from the network, such as time and/or location thresholds. The mobility procedures include for example: (initial) cell selection: cell reselection; handover; provision of location update to the network: state transitions (e.g. upon changing cells); and/or the like.

If present, the positioning module 45 is responsible for determining the position of the UE 3, for example based on Global Navigation Satellite System (GNSS) signals.

### NTN Node (Satellite/UAS Platform)

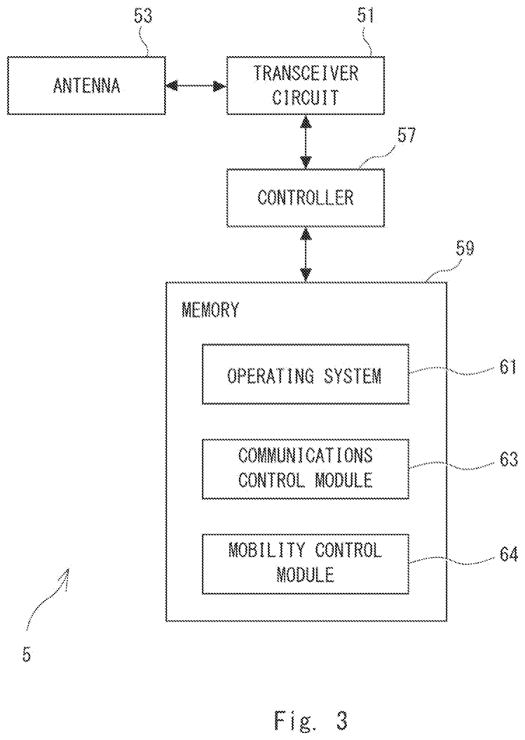

FIG. 3 is a block diagram illustrating the main components of the NTN node 5 (a satellite or a UAS platform) shown in FIG. 1. As shown, the NTN node 5 includes a transceiver circuit 51 which is operable to transmit signals to and to receive signals from connected UE(s) 3 via one or more antenna 53 and to transmit signals to and to receive signals from other network nodes such as gateways and base stations (either directly or indirectly). A controller 57 controls the operation of the NTN node 5 in accordance with software stored in a memory 59. The software may be pre-installed in the memory 59 and/or may be downloaded via the telecommunication network 1 or from a removable data storage device (RMD), for example. The software includes, among other things, an operating system 61, a communications control module 63, and a mobility control module 64.

The communications control module 63 is responsible for handling (generating/sending/receiving/relaying) signalling between the NTN node 5 and other nodes, such as the UE 3, base stations 6, gateways, and core network nodes (via the base stations/gateways). The signalling may comprise control signalling (such as RRC signalling) related to configuring and assisting cell reselection by the UE 3.

The mobility control module 64 is responsible for controlling mobility procedures for the UE 3 (in RRC connected, RRC idle, and RRC inactive state), by transmitting appropriate assistance information (e.g. configuration/parameters) to the UEs 3, such as time and/or location thresholds. The assistance information/thresholds may be provided by the gateway 6 to which the NTN node 5 is connected. The mobility procedures include for example: (initial) cell selection: cell reselection; handover: provision of location update to the network; state transitions (e.g. upon changing cells); and/or the like.

### Base Station/Gateway (Access Network Node)

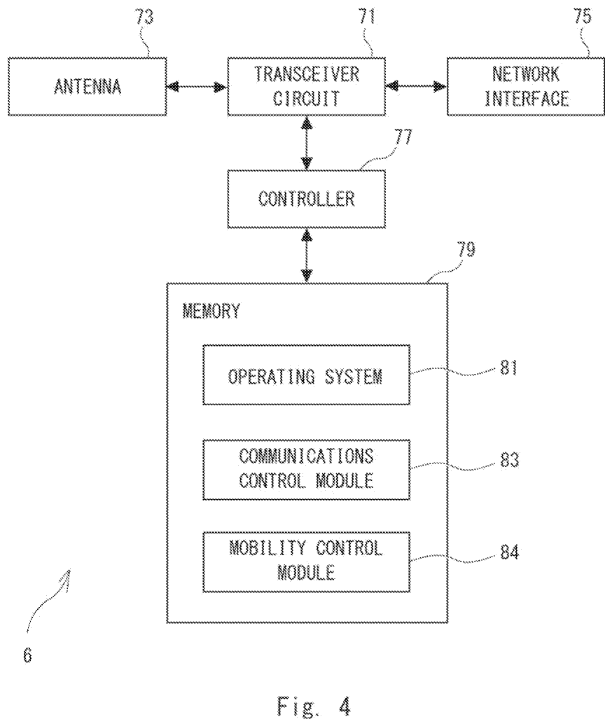

FIG. 4 is a block diagram illustrating the main components of the gateway 6 shown in FIG. 1 (a base station (gNB) or a similar access network node). As shown, the gateway/gNB 6 includes a transceiver circuit 71 which is operable to transmit signals to and to receive signals from connected UE(s) 3 via one or more antenna 73 and to transmit signals to and to receive signals from other network nodes (either directly or indirectly) via a network interface 75. Signals may be transmitted to and received from the UE(s) 3 either directly and/or via the NTN node 5, as appropriate. The network interface 75 typically includes an appropriate base station-base station interface (such as X2/Xn) and an appropriate base station-core network interface (such as S1/NG-C/NG-U). A controller 77 controls the operation of the base station 6 in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and a mobility control module 84.

The communications control module 83 is responsible for handling (generating/sending/receiving) signalling between the base station 6 and other nodes, such as the UE 3, NTN nodes 5, and core network nodes. The signalling may comprise control signalling (such as RRC signalling) related to configuring and assisting cell reselection by the UE 3.

The mobility control module 84 is responsible for controlling mobility procedures for the UE 3 (in RRC connected, RRC idle, and RRC inactive state), by providing appropriate assistance information (e.g. configuration/parameters) to the UEs 3, such as time and/or location thresholds. The mobility procedures include for example: (initial) cell selection; cell reselection: handover: provision of location update to the network: state transitions (e.g. upon changing cells); and/or the like.

### DETAILED DESCRIPTION

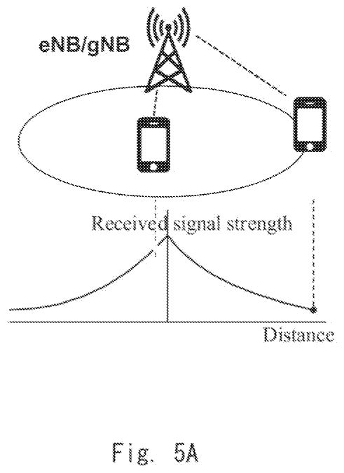

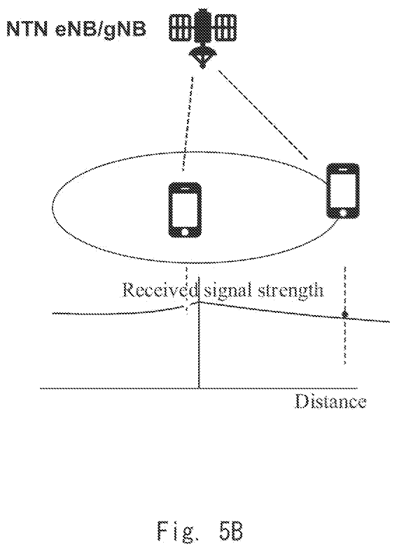

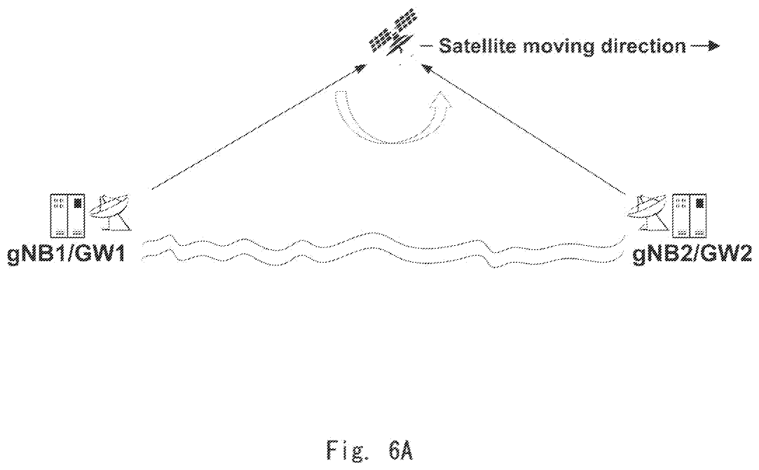

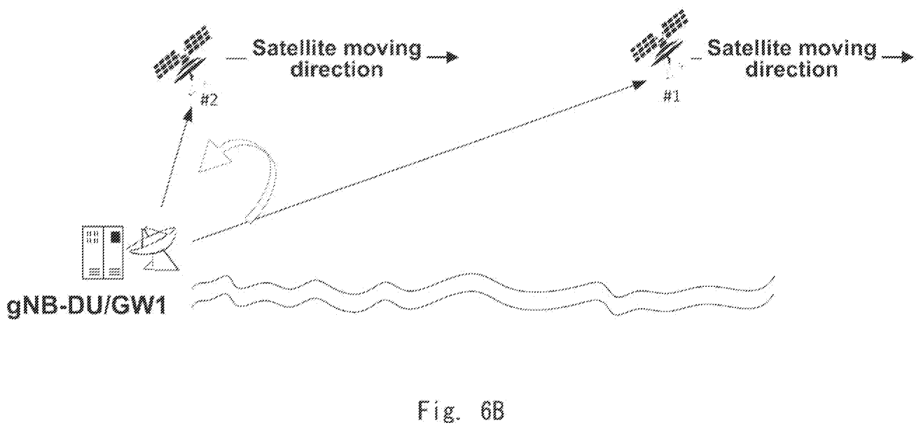

The following is a description of some exemplary cell (re)selection procedures performed by the nodes of the system shown in FIG. 1. The procedures may be particularly beneficial in the exemplary scenarios shown in FIGS. 5A, 5B, 6A and 6B.

A UE may be configured to not measure intra-frequency cells and/or inter-frequency cells of equal or lower priority if the serving cell's Srxlev/Squal is higher than their configured thresholds. However, the UE always measures inter-frequency cell cells of higher priority.

In more detail, section 5.2.4.2 of NPL 4 describes the following measurement rules for cell re-selection, to be used by the UE to limit needed measurements:
If the serving cell fulfils Srxlev>S_{IntraSearchP} and Squal>S_{IntraSearchQ}, the UE may choose not to perform intra-frequency measurements. The ‘Srxlev’ cell selection sub-criterion specifies a cell selection receiver (RX) level value (in dB) and the ‘Squal’ cell selection sub-criterion specifies a cell selection quality value (in dB). S_{IntraSearchP} is the power threshold associated with the Srxlev sub-criterion of the serving cell to perform intra-frequency measurements, and S_{IntraSearchQ} is the quality threshold associated with the Squal sub-criterion of the serving cell to perform intra-frequency measurements.
Otherwise, the UE shall perform intra-frequency measurements (i.e. in case the serving cell does not fulfil one or both of Srxlev>S_{IntraSearchP} and Squal>S_{IntraSearchQ}).
The UE shall apply the following rules for NR inter-frequencies and inter-RAT frequencies which are indicated in system information and for which the UE has priority provided as defined in section 5.2.4.1 of NPL 4:
   For a NR inter-frequency or inter-RAT frequency with a reselection priority higher than the reselection priority of the current NR frequency, the UE shall perform measurements of higher priority NR inter-frequency or inter-RAT frequencies according to NPL 5.
   For a NR inter-frequency with an equal or lower reselection priority than the reselection priority of the current NR frequency and for inter-RAT frequency with lower reselection priority than the reselection priority of the current NR frequency:
      If the serving cell fulfils Srxlev>S_{nonIntraSearchP} and Squal>S_{nonIntraSearchQ}, the UE may choose not to perform measurements of NR inter-frequency cells of equal or lower priority, or inter-RAT frequency cells of lower priority;
      Otherwise, i.e. in case the serving cell does not fulfil at least one of Srxlev>S_{IntraSearchP} and Squal>S_{IntraSearchQ}, the UE shall perform measurements of NR inter-frequency cells of equal or lower priority, or inter-RAT frequency cells of lower priority according to NPL 5.
If the UE supports relaxed measurement and the information element (IE) relaxedMeasurement is present in system information block type 2 (SIB2), the UE may further relax the needed measurements, as specified in clause 5.2.4.9 of NPL 4.

In this system the UEs 3 may be configured to use a location-assisted cell reselection technique. This technique may be used in NTN cells which have a relatively low signal strength variation from cell centre to cell edge. Alternatively, or additionally, the UEs 3 may also be configured to use a time-assisted cell reselection technique. This technique may be used in NTN cells which may be switched on and off (e.g. depending on system load).

It will be appreciated that some UEs 3 (or some types/class of UEs) may be configured to use the location-assisted cell reselection technique, some UEs may be configured to use the time-assisted cell reselection technique, and some UEs may be configured to use both the location-assisted and time-assisted cell reselection techniques.

### Time-Assisted Cell Reselection

Regarding time-assisted (or time-based) cell reselection the following assumptions apply based on the latest agreements in 3GPP:
For quasi-earth fixed cells, the timing information on when a cell is going to stop serving the area for earth fixed scenario is broadcast to UE via system information. Typically, quasi-earth fixed cells are provided via NGEO satellites using steerable beams since in this case the beam(s) cover one geographic area (i.e. a quasi-earth fixed cell) for a finite period and a different geographic area for another period.
For a quasi-earth fixed cell, the timing information on when the cell is going to stop serving an area refers to the time when the cell stops covering the current area. The timing information is broadcast in the cell.
For a quasi-earth fixed cell, the UE 3 starts measurements on its neighbour cells (that are candidates for cell selection) before the stop time of the serving cell indicated via the timing information. In other words, the UE 3 tries to complete the measurements and cell reselection before the serving cell stops covering the current area to avoid going out of coverage.

The following is description of an exemplary way (‘Option 1’) in which timing information (e.g. cell stop time) of a neighbouring cell may be used to assist cell reselection by the UE 3.

### Option 1

The UE 3 may be configured to exclude those neighbouring cells from cell reselection which have a remaining serving time less than an associated threshold.

The timing information on when a particular neighbouring cell is going to stop serving an area is broadcast to the UEs 3 via system information. This information may be broadcast for at least some NTN cells such as quasi-earth fixed cells. This information may be obtained via OAM configuration and/or shared between neighbouring base stations 6 via the base station-to-base station interface between them. A time threshold (also referred to as a ‘first threshold’ or ‘first exclusion threshold’) may also be configured via system information.

The UE 3 in idle or inactive state can read the system information and execute measurement and cell reselection by taking into account any timing information and any other applicable configurations.

Specifically, in this case, the UE 3 is configured to exclude any cell from measurement if that cell's remaining serving time (the time until the point in time when the cell will stop serving the current area) is less than the time threshold associated with that cell. In other words, even if a particular cell would be the best cell on the frequency, the UE 3 does not measure that cell (or ignores any associated measurement results), and it does not reselect to that cell if the timing information indicates that the cell is going to stop serving the current area relatively soon.

### Location-Assisted Cell Reselection

Regarding the location-assisted (or location-based) cell reselection the following assumptions apply based on the latest agreements in 3GPP:
For a quasi-earth fixed cell, the reference location of the cell (serving cell or neighbour cell) is broadcast in the system information. The reference location is defined as the cell centre (although any other suitable reference location may be used if appropriate).
Location assisted cell reselection, based on the distance between the UE 3 and the reference location of the cell (serving cell and/or neighbour cell), is supported for quasi-earth fixed cells, in case the UE 3 has valid (recent or current) location information. It will be appreciated that location acquisition will not be triggered at the UE side only for location assisted cell reselection (although it may be possible in some cases).

The following is description of some exemplary ways (referred to as ‘Option 2’ through ‘Option 4’) in which location information may be used to assist cell reselection by the UE 3. The location information may be applicable to the distance between the UE 3 and the reference location of its serving cell and/or the distance between the UE 3 and the reference location of a neighbour cell (that is a candidate for cell selection).

### Option 2

A UE 3 may be configured to not perform measurement on certain neighbouring frequencies/cells e.g. intra and inter frequency cells (at least cells with lower or equal priority to that of the current cell) if the UE's distance to the serving cell is smaller than an associated threshold (i.e. when the UE is relatively close to the cell centre or a reference point of its current serving cell). In case the UE 3 does perform measurements with respect to such cells, the UE 3 may be configured to exclude or ignore these measurements in its cell reselection process.

In more detail, the reference location of the serving cell (e.g. cell centre on ground) or information relevant to reference location of the serving cell (e.g. ephemeris information) is broadcast/sent to the UEs 3 via e.g. system information. This information may be broadcast for at least some NTN cells such as quasi-earth fixed cells, and the information may be shared between neighbouring base stations. The base station 6 may configure at least one distance threshold (e.g. a ‘second threshold’ or ‘first exclusion threshold’) associated with the serving cell to assist the UEs 3 in determining when to stop/trigger measurement on a neighbouring cell on certain frequencies or certain type of neighbouring cells. It will be appreciated that a different associated second threshold may be configured for different neighbour cells, different frequencies, and/or different types of cells.

Option 2-1: only one distance threshold applicable to all neighbouring cells.

Option 2-2: multiple distance thresholds, in which case:
one distance threshold may be applicable per frequency: or
one distance threshold may be applicable for inter-frequency cells (with equal or lower priority) and another distance threshold may be applicable for intra-frequency cells: or
one distance threshold may be applicable for each neighbouring cell type e.g. TN neighbouring frequencies/cells, GEO neighbouring frequency/cells, LEO neighbouring frequencies/cells, etc.

If the UE 3 has valid location information for itself, then it calculates the distance to the serving cell's reference location before proceeding to perform cell reselection related measurements. If the distance from the UE's location to the serving cell reference location is less than the configured second threshold, then the UE 3 does not perform measurements on the corresponding neighbouring frequencies, cells, or cell types (although the UE 3 may still perform measurements for other cells for which a different threshold applies or no threshold applies). If the distance from the UE's location to the serving cell reference location is more than (or at least equal to) the configured second threshold, then the UE 3 performs measurement on the corresponding neighbouring frequencies/cell/types and proceeds to perform cell reselection based on the results of these measurements.

### Option 3

A UE 3 may be configured to apply relaxed measurements if at least one of following conditions is fulfilled:
the UE's distance to the serving cell is smaller than an associated threshold relating to the cell edge (i.e. a threshold for determining whether the UE 3 is at the cell edge); and
the UE's speed is lower than an associated threshold or the UE's location change is less than an associated threshold (i.e. a threshold for determining low mobility).

Relaxed measurements for intra-frequency cells, inter-frequency cells and inter-RAT frequency cells is performed according to relaxation methods in clauses 4.2.2.9, 4.2.2.10, and 4.2.2.11 in NPL 5.

The base station 6 may broadcast parameters relevant to location-assisted cell reselection by the UEs 3. These parameters may be applicable to at least those UEs 3 that are not located at or near the edge of their serving cell. In order to assist the UEs 3 determining whether they are located at the cell edge, the base station 6 broadcasts (or otherwise provides) an associated distance threshold (e.g. a ‘third threshold’ or ‘first relaxation threshold’).

If a UE 3 has valid location information for itself, it can calculate its distance to the reference location of the serving cell. If the distance to the serving cell reference location is less than the configured (third) threshold, the UE 3 can apply relaxed measurement on all or some neighbouring frequencies/cells/cell types.

The base station 6 may also broadcast parameters relevant to location-assisted cell reselection by UEs 3 with low mobility. Specifically, the parameters may include at least one of a speed threshold or a location change threshold (e.g. a ‘fourth threshold’ or ‘first relaxation threshold’) within a configured time window. Thus, in this case, a fourth threshold may be used for determining low mobility and it may be provided in the form of a speed threshold or a location change threshold.

If a UE 3 has valid location information for itself, it can calculate its speed or (rate of) location change within the configured time window.

If the UE's speed is lower than the configured speed threshold or if the UE's location change is less than the location change threshold (in the configured time window), then the UE 3 applies relaxed measurement on all or some neighbouring frequencies/cells/cell types.

In summary, the UE 3 may apply the relaxed measurements by taking into account at least one threshold associated with the serving cell, wherein the at least one threshold may comprise at least one of: a distance threshold: a speed threshold; and a location change threshold.

### Option 4

A UE 3 may be configured to exclude those neighbouring cells from cell reselection to which the distance from the UE's current location is larger than an associated threshold (i.e. when the UE is relatively far from the edge, centre, or a suitable reference point of that neighbour cell).

In more detail, the base station 6 may broadcast ephemeris information for the neighbouring cells and/or information identifying a respective reference location associated with the neighbouring cells.

The base station 6 may also broadcast an appropriate distance threshold (also referred to as a ‘fifth threshold’ or ‘second exclusion threshold’) associated with a particular neighbouring cell (or a group of cells). The base station 6 may broadcast a plurality of distance thresholds for each neighbouring cell or each type of neighbouring cell, for example, a distance threshold per satellite type (GEO, MEO, LEO, non-satellite, etc.). Alternatively, the fifth threshold may be provided per neighbour cell or frequency.

Based on its current location and the reference location associated with the neighbouring cells, the UE 3 can then calculate the distance to any indicated/detected neighbouring cell. If its distance to a particular neighbouring cell is more than the corresponding distance threshold, then the UE 3 does not reselect to that cell. In other words, the UE 3 may be configured to exclude one or more neighbour cell or frequency from cell reselection based on the associated fifth threshold.

### Modifications and Alternatives

Detailed embodiments have been described above. As those skilled in the art will appreciate, a number of modifications and alternatives can be made to the above embodiments whilst still benefiting from the disclosures embodied therein. By way of illustration only a number of these alternatives and modifications will now be described.

It will be appreciated that the above-described thresholds may be applied to a certain class/type of UEs (for example IoT UEs or power saving UEs rather than all UEs), and different thresholds may be defined for different class/type of UEs. The thresholds may be (re)configured via dedicated signalling. The dedicated signalling may comprise appropriately formatted RRC signalling (e.g. an RRC Connection Reconfiguration message and/or the like) including one or more information element. The one or more information element may include information identifying at least one threshold and/or information identifying at least one UE category (e.g. UE class/type). However, the thresholds (or default values) may also be factory configured for each UE (e.g. depending on its class/type, and/or network operator). It will be appreciated that different thresholds (or different sets of thresholds) may be configured for different types of satellites (GEO, MEO, LEO, etc.).

TABLE 1
types of satellites and UAS platforms

| | | | | Typical beam | |
|---|---|---|---|---|---|
| Platforms | Altitude range | | Orbit | footprint size | |
| Low-Earth Orbit | 300-1500 | km | Circular around the earth | 100-1000 | km |
| (LEO) satellite | | | | | |
| Medium-Earth Orbit | 7000-25000 | km | | 100-1000 | km |
| (MEO) satellite | | | | | |
| Geostationary Earth | 35 786 | km | Notional station keeping | 200-3500 | km |
| Orbit (GEO) satellite | | | position fixed in terms of | | |
| UAS platform | 8-50 km | | elevation/azimuth with | 5-200 | km |
| (including HAPS) | (20 km for HAPS) | | respect to a given earth | | |
| | | | point | | |
| High Elliptical Orbit | 400-50000 | km | Elliptical around the earth | 200-3500 | km |
| (HEO) satellite | | | | | |

Whilst the above-described exemplary procedures are discussed in the context of cell reselection (in RRC idle or RRC inactive state), it will be appreciated that the same approach may be applied to other types of mobility procedures such as (initial) cell selection, cell measurement/selection for handover, and/or the like. It will be appreciated that similar time and/or location threshold(s) may be used in other types of procedures such as cell measurement or cell selection for carrier aggregation/dual connectivity/supplementary uplink.

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). NPL 6 and NPL 7 define the following nodes, amongst others:
gNB: node providing NR user plane and control plane protocol terminations towards the UE, and connected via the NG interface to the 5G core network (5GC).
ng-eNB: node providing E-UTRA user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).

NG-RAN node: either a gNB or an ng-eNB.

It will be appreciated that the above embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

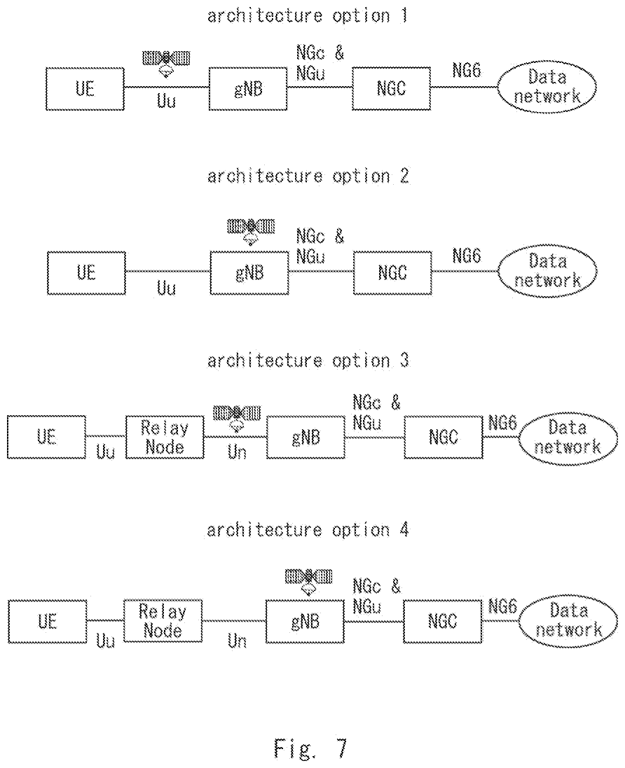

It will be appreciated that there are various architecture options to implement NTN in a 5G system, some of which are illustrated schematically in FIG. 7. The first option shown is an NTN featuring an access network serving UEs and based on a satellite/aerial with bent pipe payload and gNB on the ground (satellite hub or gateway level). The second option is an NTN featuring an access network serving UEs and based on a satellite/aerial with gNB on board. The third option is an NTN featuring an access network serving Relay Nodes and based on a satellite/aerial with bent pipe payload. The fourth option is an NTN featuring an access network serving Relay Nodes and based on a satellite/aerial with gNB. It will be appreciated that other architecture options may also be used, for example, a combination of two or more of the above-described options. Alternatively, the relay node may comprise a satellite/UAS. It will be appreciated that similar architecture options may be used in 4G/LTE systems as well, but with an eNB instead of the gNB, an EPC instead of NGC, and using the appropriate LTE interfaces instead of the NG interfaces shown in FIG. 7.

Each cell has an associated ‘NR Cell Global Identifier’ (NCGI) to identify the cell globally. The NCGI is constructed from the Public Land Mobile Network (PLMN) identity (PLMN ID) the cell belongs to and the NR Cell Identity (NCI) of the cell. The PLMN ID included in the NCGI is the first PLMN ID within the set of PLMN IDs associated to the NR Cell Identity in System Information Block Type 1 (SIB1). The ‘gNB Identifier’ (gNB ID) is used to identify a particular gNB within a PLMN. The gNB ID is contained within the NCI of its cells. The ‘Global gNB ID’ is used to identify a gNB globally and it is constructed from the PLMN identity the gNB belongs to and the gNB ID. The Mobile Country Code (MCC) and Mobile Network Code (MNC) are the same as included in the NCGI.

In the above description, the UE, the NTN node (satellite/UAS platform), and the access network node (base station) are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors: microprocessors: central processing units (CPUs): arithmetic logic units (ALUs): input/output (IO) circuits: internal memories/caches (program and/or data): processing registers: communication buses (e.g. control, data and/or address buses); direct memory access (DMA) functions: hardware or software implemented counters, pointers and/or timers; and/or the like.

In the above embodiments, a number of software modules were described. As those skilled in the art will appreciate, the software modules may be provided in compiled or un-compiled form and may be supplied to the UE, the NTN node, and the access network node (base station) as a signal over a computer network, or on a recording medium. Further, the functionality performed by part or all of this software may be performed using one or more dedicated hardware circuits. However, the use of software modules is preferred as it facilitates the updating of the UE, the NTN node, and the access network node (base station) in order to update their functionalities.

The above embodiments are also applicable to ‘non-mobile’ or generally stationary user equipment. The above-described mobile device (UE) may comprise an MTC/IoT device, a power saving UE, and/or the like.

The method performed by the UE may comprise obtaining said respective timing information for the corresponding candidate cell (e.g. from the serving cell's system information).

The method performed by the UE may comprise obtaining configuration information for said set of at least one candidate cell, comprising information identifying a respective location associated with a given candidate cell.

The method performed by the UE may comprise obtaining at least a part of said configuration information via system information or via dedicated signalling (e.g. RRC signalling comprising at least one information element).

The configuration information may comprise at least one of said first to fifth thresholds. The first to fifth thresholds may be applicable based on a class or type of the UE (e.g. IoT UEs and/or power saving UEs).

The remaining serving time may be determined based on a time remaining until that cell will stop serving a current area. The distance from the current location of the UE to its serving cell or a candidate cell may be determined based on a centre point or a reference point of that cell (compared to a current location of the UE).

The method performed by the UE may comprise excluding from said measurement or from said cell selection at least one intra frequency cell or inter frequency cell with a lower or an equal priority to that of the current cell in a case that a distance from the current location of the UE to its serving cell is smaller than the second threshold.

The method performed by the UE may further comprise ranking cells in said set of at least one candidate cell and performing a cell selection based on said ranking.

The UE may be in a Radio Resource Control (RRC) idle state or an RRC inactive state when performing said measurements and said cell selection. The cell selection may comprise cell reselection (e.g. using cell selection criteria Srxlev and Squal specified by 3GPP). The measurements may be performed, with respect to each cell in said set of at least one candidate cell, over associated Channel State Information Reference Signal (CSI-RS) resources.

Various other modifications will be apparent to those skilled in the art and will not be described in further detail here.

The whole or part of the exemplary embodiments disclosed above can be described as, but not limited to, the following supplementary notes.

### (Supplementary Note 1)

A method performed by a user equipment (UE) configured to communicate via a network including a non-terrestrial network portion, the method comprising:
performing a procedure including:
   performing measurements with respect to at least one cell in a set of candidate cells; and
   performing a cell selection based on a result of the measurements, and
wherein the procedure is performed based on at least one parameter for the at least one cell including at least one of:
   remaining serving time of each of the at least one cell,
   distance between a current location of the UE and each of the at least one cell,
   distance between the current location of the UE and a serving cell, and mobility of the UE.

### (Supplementary Note 2)

The method according to Supplementary Note 1, wherein
the procedure includes excluding, from the measurements or from the cell selection, a measurement of a cell having a value corresponding to the at least one parameter less than a first exclusion threshold.

### (Supplementary Note 3)

The method according to Supplementary Note 1 or 2, wherein
the procedure includes applying relaxed measurement in a case where the mobility of the UE is less than a first relaxation threshold.

### (Supplementary Note 4)

The method according to any one of Supplementary Notes 1 to 3, wherein
the procedure includes excluding, from the measurements or from the cell selection, a measurement of a cell having a value corresponding to the at least one parameter more than a second exclusion threshold.

### (Supplementary Note 5)

The method according to any one of Supplementary Notes 1 to 4, wherein
the procedure includes performing measurements for inter-frequency cells, and measurements for intra-frequency cells, and
values of thresholds which are applied to the procedure are different among the inter-frequency cells and the intra-frequency cells.

### (Supplementary Note 6)

The method according to any one of Supplementary Notes 1 to 5, wherein values of thresholds which are applied to the procedure are different among frequencies in which the each of the at least one cell is operated.

### (Supplementary Note 7)

The method according to any one of Supplementary Notes 1 to 6, wherein the procedure is performed based on a class or type of the UE.

### (Supplementary Note 8)

The method according to any one of Supplementary Notes 1 to 7, wherein the remaining serving time is determined based on a time remaining until a cell corresponding to the remaining serving time will stop serving in a current area.

### (Supplementary Note 9)

The method according to any one of Supplementary Notes 1 to 8, wherein the distance from the current location of the UE to the each of the at least one cell is determined based on a centre point or a reference point of the each of the at least one cell.

### (Supplementary Note 10)

The method according to Supplementary Note 9, further comprising receiving location information identifying a reference location for determining the centre point or the reference point of the each of the at least one cell.

### (Supplementary Note 11)

The method according to Supplementary Note 2, wherein the excluding is performed to a cell with a lower or an equal priority to a priority of the serving cell.

### (Supplementary Note 12)

The method according to Supplementary Note 10, wherein the receiving location information including receiving configuration information including the location information.

### (Supplementary Note 13)

The method according to Supplementary Note 11, wherein the configuration information is transmitted via system information or via dedicated signalling.

### (Supplementary Note 14)

The method according to Supplementary Note 11 or 12, further comprising the configuration information includes at least one of the first exclusion threshold, the first relaxation threshold and the second exclusion threshold.

### (Supplementary Note 15)

The method according to any one of Supplementary Notes 1 to 14, wherein the UE is in a Radio Resource Control (RRC) idle state or an RRC inactive state when performing the procedure.

### (Supplementary Note 16)

The method according to any one of Supplementary Notes 1 to 15, further comprising receiving the at least one parameter via system information.

### (Supplementary Note 17)

The method according to any one of Supplementary Notes 1 to 11, further comprising:
ranking cells in the set of the at least one cell; and wherein
the performing the cell selection is performed based on the ranking.

### (Supplementary Note 18)

The method according to any one of Supplementary Notes 1 to 12, wherein the performing measurements is performed over associated Channel State Information Reference Signal (CSI-RS) resources.

### (Supplementary Note 19)

A method performed by a network node configured to communicate with a user equipment (UE) via a network including a non-terrestrial network portion, the method comprising:
providing, to the UE, configuration information which is configured to assist the UE in performing a procedure including:
   performing measurements with respect to at least one cell in a set of candidate cells; and
   performing a cell selection based on a result of the measurements, and
wherein the procedure is performed based on at least one parameter for the at least one cell including at least one of:
   remaining serving time of each of the at least one cell,
   distance between a current location of the UE and each of the at least one cell,
   distance between the current location of the UE and a serving cell, and mobility of the UE;
wherein the configuration information includes at least one threshold for the procedure.

### (Supplementary Note 20)

A user equipment (UE) configured to communicate via a network including a non-terrestrial network portion, the UE comprising:
means for performing a procedure including:
   performing measurements with respect to at least one cell in a set of candidate cells; and
   performing a cell selection based on a result of the measurements, and
wherein the procedure is performed based on at least one parameter for the at least one cell including at least one of:
   remaining serving time of each of the at least one cell,
   distance between a current location of the UE and each of the at least one cell,
   distance between the current location of the UE and a serving cell, and mobility of the UE.

### (Supplementary Note 21)

A network node configured to communicate with a user equipment (UE) via a network including a non-terrestrial network portion, the network node comprising:
means for providing, to the UE, configuration information which is configured to assist the UE in performing a procedure including:
   performing measurements with respect to at least one cell in a set of candidate cells; and
   performing a cell selection based on a result of the measurements, and
wherein the procedure is performed based on at least one parameter for the at least one cell including at least one of:
   remaining serving time of each of the at least one cell,
   distance between a current location of the UE and each of the at least one cell,
   distance between the current location of the UE and a serving cell, and mobility of the UE.

This application is based upon and claims the benefit of priority from Great Britain Patent Application No. 2115145.1, filed on Oct. 21, 2021, the disclosure of which is incorporated herein in its entirety by reference.

### REFERENCE SIGNS LIST

1 mobile (cellular or wireless) telecommunication system
3 mobile device
5 satellite
6 base station
7 data (or core) network
31 transceiver circuit
33 antenna
35 user interface
37 controller
39 memory
41 operating system
43 communications control module
44 mobility module
45 positioning module
51 transceiver circuit
53 antenna
57 controller
59 memory
61 operating system
63 communications control module
64 mobility control module
71 transceiver circuit
73 antenna
75 network interface
77 controller
79 memory
81 operating system
83 communications control module
84 mobility control module

What is claimed is:

1.-21. (canceled)

22. A method performed by a user equipment (UE) configured to communicate via a network including a non-terrestrial network, the method comprising:
receiving system information including at least one threshold and information indicating a reference location of a serving cell; and
determining not to perform a measurement on at least one frequency cell of equal or lower priority than the serving cell in a case where a distance between a current location of the UE and the reference location of the serving cell is shorter than the at least one threshold.

23. The method according to claim 22, wherein
the determining is performed in a case where the UE has valid information indicating the current location of the UE.

24. The method according to claim 22, wherein
the at least one threshold includes a respective threshold appliable per frequency.

25. The method according to claim 22, wherein
the at least one threshold includes a threshold applicable for inter-frequency measurement and another threshold applicable for intra-frequency measurement.

26. The method according to claim 22, wherein
the at least one threshold includes a respective threshold appliable per type of neighbor cells.

27. The method according to claim 22, wherein
the measurement is performed based on remaining serving time of the serving cell.

28. The method according to claim 27, wherein
information indicating the remaining serving time of the serving cell is included in the system information.

29. A method performed by a network node configured to communicate with a user equipment (UE) via a network including a non-terrestrial network, the method comprising:
transmitting, to the UE, system information including at least one threshold and information indicating a reference location of a serving cell;
wherein the at least one threshold and the reference location of a serving cell are used, by the UE, for determining not to perform a measurement on at least one frequency cell of equal or lower priority than the serving cell in a case where a distance between a current location of the UE and the reference location of the serving cell is shorter than the at least one threshold.

30. A user equipment (UE) configured to communicate via a network including a non-terrestrial network, the UE comprising:
at least one memory storing instructions; and
at least one processor configured to process the instructions to:
receive system information including at least one threshold and information indicating a reference location of a serving cell; and
determine not to perform a measurement on at least one frequency cell of equal or lower priority than the serving cell in a case where a distance between a current location of the UE and the reference location of the serving cell is shorter than the at least one threshold.

31. A network node configured to communicate with a user equipment (UE) via a network including a non-terrestrial network, the network node comprising:
at least one memory storing instructions; and
at least one processor configured to process the instructions to:
transmit, to the UE, system information including at least one threshold and information indicating a reference location of a serving cell;
wherein the at least one threshold and the reference location of a serving cell are used, by the UE, for determining not to perform a measurement on at least one frequency cell of equal or lower priority than the serving cell in a case where a distance between a current location of the UE and the reference location of the serving cell is shorter than the at least one threshold.
